(19) United States
(12) Patent Application Publication
(10) Pub. No.: US 2008/0143731 A1
(43) Pub. Date: Jun. 19, 2008

(54) Video rendering across a high speed peripheral interconnect bus

(76) Inventors: Jeffrey Cheng, Toronto (CA); Terry Laviolette, Courtice (CA); James Huang, North York (CA); Robert Zabrzycki, Mississauga (CA); Jason Long, Richmond Hill (CA); Xiangquan Weng, Toronto (CA); Sasa Marinkovic, Toronto (CA); Phil Mummah, Redwood City, CA (US); Mingwei Chien, Toronto (CA); Michael Tresidder, Newmarket (CA); Roumen Saltchev, Markham (CA); George Xie, North York (CA); Iouri Litchmanov, Richmond Hill (CA)

Correspondence Address: Ralph A. Dowell of DOWELL & DOWELL P.C., 2111 Eisenhower Ave, Suite 406, Alexandria, VA, 22314, US

(21) Appl. No.: 11/987,559

(22) Filed: Nov. 30, 2007

Related U.S. Application Data
(63) Continuation-in-part of application No. 11/136,483, filed on May 24, 2005.
Application No. 11/136,483 is a continuation-in-part of application No. 11/421,005, filed on May 30, 2006.

(51) Int. Cl. G06F 15/16

(52) U.S. Cl. 345/502; 345/545; 345/537

(57) ABSTRACT

Graphics generated by one graphics processor are transferred across a high speed interconnect bus to a frame buffer. The rendered frames from the frame buffer are presented on a display by way of a display interface in communication with the frame buffer. The display interface of another existing (e.g. integrated) graphics adapter/subsystem may be used to present the rendered frames on an interconnected display.

### CROSS-REFERENCE TO RELATED APPLICATIONS

The present application is a continuation-in-part of U.S. patent application Ser. Nos. 11/136,483 filed May 24, 2005 and U.S. patent application Ser. No. 11/421,005 filed May 30, 2006, the contents of both of which are hereby incorporated by reference.

### FIELD OF THE INVENTION

The present invention relates generally to computing devices, and more particularly to a computing device including graphics processors interconnected by a high speed peripheral bus.

### BACKGROUND OF THE INVENTION

In recent years, computer hardware has become increasingly integrated. Computer peripherals are often formed as part of an integrated chipset that cooperates with a central processor. Often, computer audio, graphics adapters and interfaces form part of the integrated chipsets. Such integration reduces costs and size of the computing devices.

At the same time, graphics processors are steadily evolving to provide enhanced performance and features. Leading graphics processors are nearly as complex as central processors. Thus, despite trends in integration, high performance graphics processors are still typically formed on peripheral cards. Integrated graphics processors, are by comparison, relatively simple and do not provide the features or performance of the high performance, graphics processors formed on peripheral cards. In the presence of an add-on peripheral card, integrated graphics components when present, are typically redundant and therefore disabled.

Similarly, as graphics adapters, whether integrated or external, are upgraded there is often no role for less powerful adapters, and these are disposed of or disabled.

Accordingly, there remains to reduce component redundancy.

### SUMMARY OF THE INVENTION

In accordance with an aspect of the present invention, graphics generated by one graphics processor are transferred across a high speed expansion/interconnect bus to a frame buffer. The rendered frames from the frame buffer are presented on a display by way of a display interface in communication with the frame buffer.

Conveniently, the display interface of another existing (e.g. integrated) graphics adapter/subsystem may be used to present the rendered frames on an interconnected display.

In this way the graphics processor may form part of a graphics adapter that need not include a display interface or possibly even a frame buffer. Likewise, the graphics processor may be replaced with a more current graphics processor.

The graphics processor may form part of a graphics adapter contained on a peripheral expansion card

In one embodiment, a computing device may include first and second graphics adapters. Images to be displayed on a display are transferred to memory accessible by the second graphics adapter. The display interface of the second graphics adapter is used to present images within the memory of the second graphics adapter on at least one of the multiple displays. In this way, device electronics forming the display interface, as well as ports of the second adapter, may be utilized. Rendered graphics may be transferred frame by frame, or graphics primitive by graphics primitive. In the latter case, graphics are effectively rendered directly in memory accessible by the second graphics adapter. This memory may be system memory or adapter memory.

In accordance with another embodiment, a graphics processor of the second adapter can be disabled or placed in a low power mode while the first graphics processor renders frames transferred across the high speed interconnect bus.

In accordance with another aspect of the present invention, a graphics processor forming part of a first graphics adapter is operated to draw first and second images on first and second displays, respectively. The first display may be interconnected with a first display interface of the first graphics adapter. The second display may be interconnected with a second display interface of a second graphics adapter. The method comprises rendering the first and second images within memory of the first graphics adapter; transferring the second images from the memory of the first adapter to a frame buffer of the second graphics adapter; and displaying the second images from the frame buffer of the second graphics adapter on the second display, using the second display interface of the second graphics adapter.

In accordance with another aspect of the present invention, a computing device includes: a processor; computer readable memory in communication with the processor; a first graphics adapter; first adapter memory in communication with the first graphics adapter; a first display interface for presenting images on a first display; a second graphics adapter; a second display interface for presenting images on a second display; a high speed bus interconnecting the first and second graphics adapters. Program code is stored within the computer readable memory, and is executable by the processor. The program code when executed, causes the first graphics adapter to render first and second images within the first adapter memory; causes transfer of the second images from the first adapter memory to a frame buffer of the second graphics adapter; and causes the second display interface of the second graphics adapter to be programmed to display the second images from the frame buffer of the second graphics adapter on the second display.

In accordance with a further aspect, the first adapter renders a first image directly into the system memory that is accessible by the second adapter. The second adapter renders the second image into the same memory. The second adapter displays both images from the system memory.

In accordance with another aspect of the present invention, there is provided a method of operating a computing device. The computing device comprises a processor, a memory in communication with the processor, a peripheral interconnect bus interconnecting the processor to a graphics processor, and a display interface. The method comprises establishing a frame buffer in the memory; instructing the graphics processor to render video frames; transferring the video frames into the frame buffer by way of the peripheral interconnect bus; and presenting the frames from the frame buffer on a display by way of the display interface.

In accordance with yet another aspect of the present invention, there is provided a computing device. The computing device comprises a central processor, a memory in communication with the central processor, a peripheral interconnect bus interconnecting the central processor to a graphics processor, a display interface, computer executable instructions stored in the memory, adapting the computing device to: cause the graphics processor to render video frames; transfer the video frames into a frame buffer by way of the peripheral interconnect bus; and present the rendered frames from the frame buffer on a display by way of the display interface.

In accordance with another aspect of the present invention, there is provided a computing device. The computing device comprising: a central processor; memory in communication with the processor; a first frame buffer; a peripheral interconnect bus interconnecting the processor to a graphics subsystem, the graphics subsystem lacking memory defining a frame buffer local to the graphics subsystem; and a display interface in communication with the memory. The memory stores computer executable instructions adapting the graphics processor to render video frames and transfer the video frames into the first frame buffer by way of the peripheral interconnect bus.

In accordance with another aspect of the present invention, there is provided a graphics subsystem, comprising: a graphics processor, and a peripheral interconnect bus interface, for interconnecting the graphics subsystem to a host processor, the graphics subsystem lacking memory defining a frame buffer local to the graphics subsystem; and the graphics subsystem operable to render video frames and transfer the video frames into a frame buffer by way of the peripheral interconnect bus.

In accordance with another aspect of the present invention, there is provided a method of operating a first graphics processor to draw first and second images on first and second displays, respectively. The second display is interconnected with a display interface of a second graphics adapter. The method includes rendering the first and second images within memory in communication with the first graphics processor; transferring the second images to a frame buffer of the second graphics adapter; and programming the display interface of the second graphics adapter to display the second images from the frame buffer of the second graphics adapter on the second display.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a simplified block diagram of a computing device, exemplary of an embodiment of the present invention;

FIG. 2 is a simplified logical block diagram of software at the computing device of FIG. 1;

FIG. 3 is a simplified block diagram of a portion of the computing device of FIG. 1;

FIG. 4 is a further schematic block diagram of a portion of the computing device of FIG. 1;

FIG. 5A is a flow chart illustrating steps performed at the computing device of FIG. 1, exemplary of an embodiment of the present invention;

FIG. 5B schematically depicts the effects of steps of FIG. 5A on components of the device of FIG. 1;

FIG. 6A is a flow chart illustrating steps performed at the computing device of FIG. 1, exemplary of an embodiment of the present invention;

FIG. 6B schematically depicts the effects of steps of FIG. 6A on components of the device of FIG. 1;

FIGS. 7 and 8 are flow charts illustrating steps performed at the computing device of FIG. 1, exemplary of further embodiments of the present invention;

FIG. 9 is a further partial simplified schematic block diagram of portions of a computing device, exemplary of a further embodiment of the present invention;

FIG. 10, is a flow chart detailing steps performed by software at the device of FIG. 9, exemplary of embodiments of the present invention; and

FIG. 11A, 11B are simplified block diagrams illustrating operation of the device of FIG. 9; and

FIG. 12 is a further partial simplified schematic block diagram of portions of a computing device, exemplary of a further embodiment of the present invention.

### DETAILED DESCRIPTION

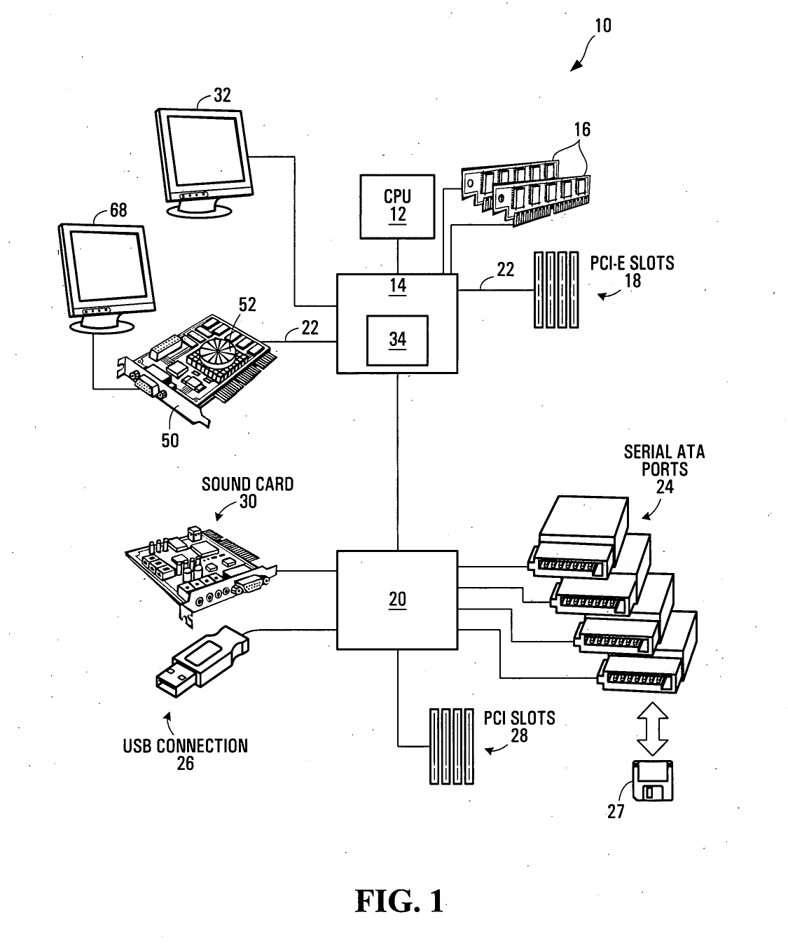

FIG. 1 is a simplified schematic block diagram of a computing device exemplary of an embodiment of the present invention. Computing device 10 is based on a conventional Intel x86 architecture. However, as will become apparent, the invention may easily be embodied in computing devices having a PowerPC, AMD x86 or other architecture.

Computing device 10 includes a processor 12, interconnected to system memory 16 and peripherals through integrated interface circuits 14 and 20.

Processor 12 in exemplary computing device 10 is a conventional central processing unit and may for example be a microprocessor compatible with the INTEL.™ x86 family of microprocessors.

Integrated interface circuits 14 and 20 are often referred to as a north bridge and south bridge, respectively, and provide an interface for processor 12 to peripherals and memory. As illustrated, north bridge 14 interconnects the processor 12; memory 16; a plurality of expansion slots 18 by way of a high speed interconnect bus 22; and south bridge 20. South bridge 20 in turn, interconnects lower speed peripherals and interconnects, such as disk drives by way of integrated IDE/SATA ports 24, universal serial bus devices by way of integrated universal serial bus (USB) ports 26; and other peripherals by way of a lower speed interconnect bus 28, compliant for example, with known PCI or ISA standards. South bridge 20 may further include integrated audio components 30, networking interfaces (not shown) and the like.

An exemplary interconnect bus 22 is the PCI express (PCIe) bus, that has a bandwidth in the gigabyte per second range, and allows data transfer reads and writes at this bandwidth. For example, current PCIe bus speeds allow bi-directional data transfer at speeds of up to 266 MHz or 533 MHz, allowing data rates of up to 2.1 G bytes per second or 4.2 G bytes per second.

In the depicted embodiment north bridge 14 further includes an integrated graphics adapter 34 suitable for interconnecting computing device 10 to a first display 32 in the form of a monitor, LCD panel, television or the like.

As detailed below, an additional graphics adapter 52 interconnected by way of interconnect bus 22, forming for example, part of peripheral expansion card 50 within expansion slots 18 on interconnect bus 22 may further be part of computing device 10.

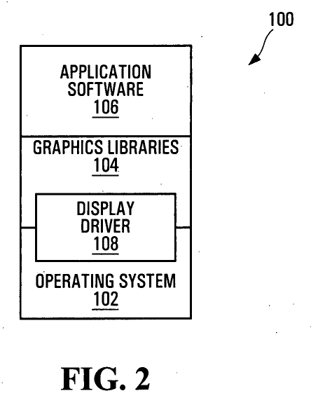

In the depicted embodiment, computing device 10 executes software stored within memory 16. As illustrated in FIG. 2, exemplary software 100 includes an operation system 102, graphics-libraries 104 and application software 106, stored within memory 16. Exemplary operating systems include Windows Vista, Windows XP; Windows NT 4.0, Windows ME; Windows 98, Windows 2000, Windows 95, or Linux operating systems. Exemplary graphics libraries include the Microsoft DirectX libraries and the OpenGL libraries. Computer memory 16 (FIG. 1) and interconnected disk drives (not shown) include a suitable combination of random access memory, read-only memory and disk storage memory, used by device 10 to store and execute operating system and graphics adapter driver programs adapting device 10 in manners exemplary of the embodiments of the present invention. Exemplary software 100 (FIG. 2) could, for example, be stored in read-only memory or loaded from an external peripheral such as a disk drive in communication with IDE/SATA ports 24. Computer readable medium 27 may be an optical storage medium, a magnetic diskette, tape, ROM cartridge or the like.

Graphics libraries 104 or operating system 102 further include a graphics driver software 108, used for low-level communication with graphics adapters 34 and 52. The software is layered, with higher level layers using lower layers to provide certain functionality. Applications may make use of the operating system 102 and graphics libraries 104 to render 2D or 3D graphics. Render, in this context, includes drawing, or otherwise creating a graphic image for presentation, and may for example include polygon rendering, ray-tracing, image decoding, line drawing or the like. As will become, apparent, software exemplary of embodiments of the present invention may form part of graphics libraries 104 and/or driver software 108. In the exemplified embodiment, exemplary software may form part of the OpenGL library and associated drivers. OpenGL is more particularly detailed in The Official Guide to Learning OpenGL, Version 1.1, the contents of which are hereby incorporated by reference. A person of ordinary skill will, however, appreciate that methods exemplary of embodiments of the present invention may form part of Microsoft Direct 3D libraries, applications (such as games) that do not use custom libraries or routine, or any other 3D application or library.

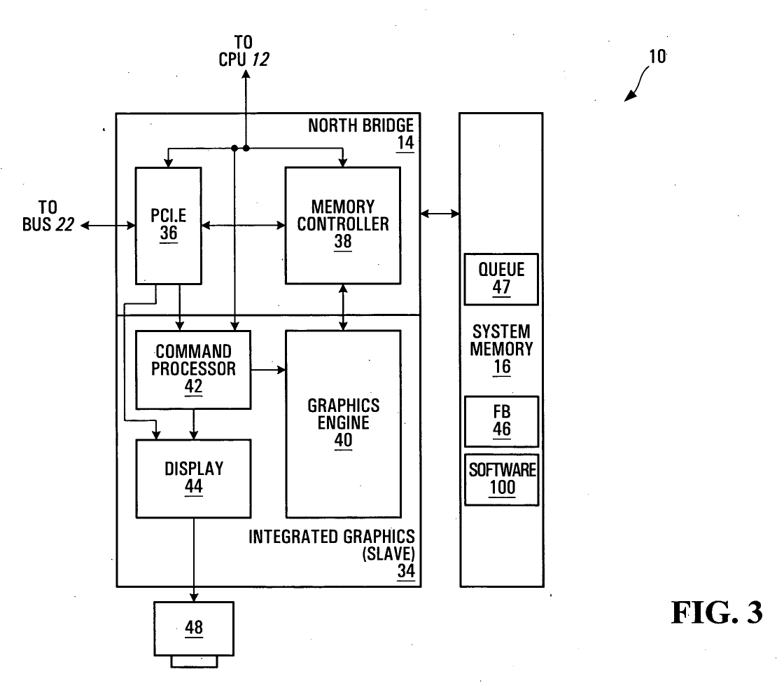

A further simplified block diagram of portions of exemplary computing device 10 (and particularly north bridge 14) depicting integrated graphics adapter 34 is illustrated in FIG. 3. As illustrated, north bridge 14 includes a high speed bus interface 36, and memory controller 38, interconnecting bridge 14 to interconnect bus 22 and system memory 16. North bridge 14 further includes integrated graphics adapter 34, that in turn includes a graphics processor 40, a command processor 42 and a display interface 44.

Graphics processor 40 may take the form of a three dimensional (3D) graphics processor capable of rendering three dimensional images within a frame buffer 46 allocated within system memory 16, and may include multiple pipelines and pipeline stages for accelerated rendering of graphics.

In normal, single monitor operation, commands are passed to graphics processor 40 by command processor 42, in a conventional manner. For example, command processor 42 may include registers used to define a command queue 47 in memory 16. Application software 106 or operating system 102 uses libraries 104 to render graphics images. Driver software 108 generates graphics processor specific commands, and places these in the command queue 47, while also updating registers of command processor 42 to reflect the end of the queue. Graphics processor 42 processes queued commands asynchronously, in a pipelined manner in order to, among other things, render images within frame buffer 46. As graphics processor 40 is able to process the next command in the queue, it provides a signal to command processor 42, which in turn fetches the next command in the queue 47 and advances the queue pointer in registers of command processor 42.

Display interface 44, by way of memory controller 38 samples the frame buffer 46 and presents an image on one or more video output ports 48 in the form of VGA ports; composite video ports; DVI ports; HDMI; DisplayPort, or the like, for display of one or more video images on video devices such as display 32 (FIG. 1), in the form of a television, monitor or the like. In this way, images rendered by graphics processor 40 in frame buffer 46 may be presented.

As will be appreciated display interface 44 may be any suitable interface for converting data within buffer for display on a display device. For example, display interface 44 may take the form of a RAMDAC. Display interface 44 is typically programmable, for example through a plurality of registers, allowing driver software 108 or similar software or graphics processor 40 to set the beginning address within memory 16 to present at its display output. As well, interface 44 pixel depth (i.e. bits per pixel) and screen resolution are typically programmable.

As will be appreciated, instead of allocating a single frame buffer 46 within memory 16, two frame buffers may be allocated. The buffers may be used alternatively to more smoothly present rendered graphics. Display interface 44 only displays contents of one of the two buffers at any time. The buffer being displayed is typically referred to as the front buffer. Graphics processor 40 renders images for display to the so-called back buffer the frame buffer that is currently not being displayed by display interface 44. At the completion of rendering a frame, front and back buffers are flipped: display interface 44 is programmed to present the former back buffer. In this way, transition between sequential frames rendered by graphics processor 40 may appear smooth.

Notably, registers and frame buffer memory 46 used by adapter 34 are all mapped to addresses within global memory space.

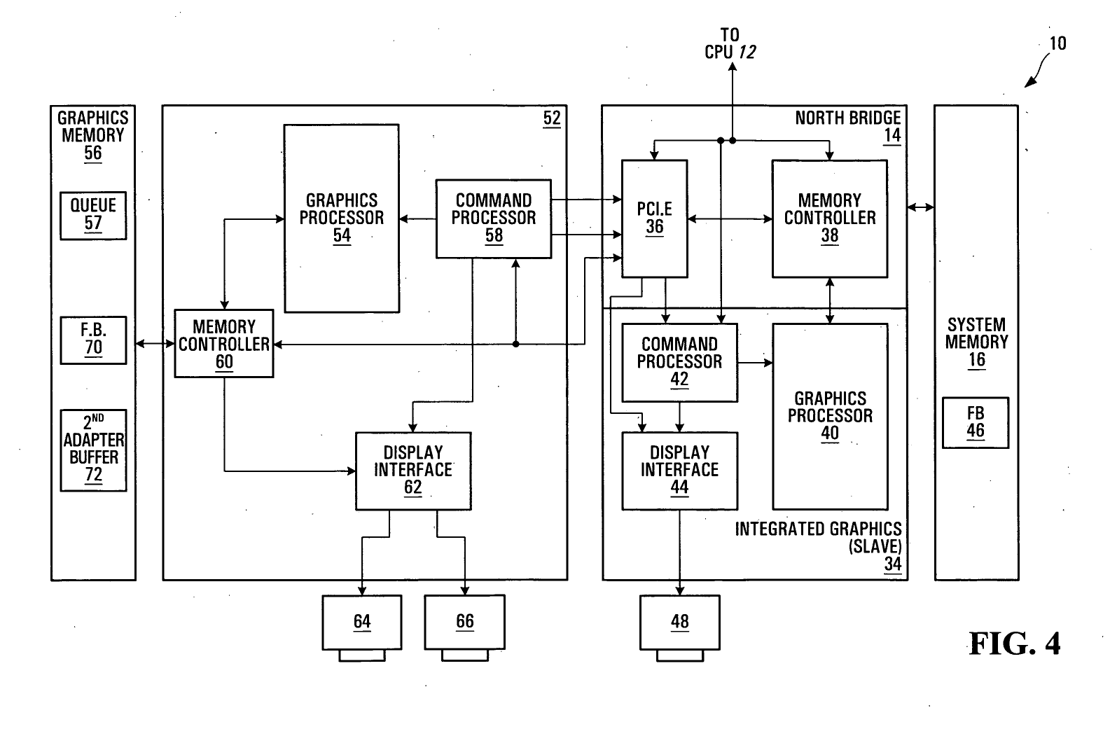

Exemplary of the present invention; however, computing device 10 further includes a graphics adapter 52 formed on a peripheral expansion card 50 that may be inserted into device 10 by way of an expansion slot on high speed interconnect bus 22, in communication with north bridge 14, as illustrated in FIG. 1. Graphics adapter 52, as interconnected to north bridge 14, is schematically illustrated in FIG. 4. As illustrated, graphics adapter 52 includes a graphics processor 54, video memory 56, a command processor 58 a memory controller 60, and a display interface 62. One or more ports 64, 66 allow interconnection of adapter 52 to one or more display devices, like display 68 (FIG. 1).

Command processor 58, and display interface 62 function in much the same way as command processor 42 and display interface 44, respectively. Graphics processor 54 operates in much the same way as graphics processor 40, in its normal mode of operation. Graphics adapter 52 includes its own memory 56, and a memory controller 60 to provide access to memory 56 and system memory 16. Local memory 56 is used to hold, among other things, one or more buffer(s) 70 for graphics adapter 52 used by graphics processor 54, that may act as frame buffer(s). A command queue 57 for graphics processor 54 is also established in system memory 16.

Again, local memory 56 is addressable at addresses within global system memory space, through memory controller 60. As well, registers used by command processor 54 and display interface 62 are addressable at addresses within global address space. As already noted, registers and frame buffer 46 used by adapter 34 are mapped to global memory space. Thus, command processor 58 and graphics processor 54 may write to frame buffer 46 and registers used by display interface 44 and command processor 42.

Additionally, graphics processor 54, in conjunction with memory controller 60 is operable to perform block transfer operations to transfer data from and to system and adapter memory 16, 56 at memory addresses.

In an effort to provide economical integrated components, integrated graphics adapter 34 provides limited functionality. For example, resolution, 3D graphics abilities, and the like of integrated graphics controller are relatively limited. Thus, integrated graphics adapter 34 typically has significantly less graphics processing ability than graphics adapter 52. For example, adapter 34 may operate more slowly than adapter 52, provide less features, and the like.

Now, integrated adapter 34 or adapter 52 may, or may not, by itself allow the interconnection of multiple physical display devices, by way of multiple ports like port 48. Each adapter, however, may be interconnected with at least one physical display. So, exemplary of embodiments of the present invention, adapter driver software 108 loaded within memory 16 causes graphics adapter 52 to act as a master (or first) graphics adapter rendering graphics for presentation at both displays 32 and 68, and graphics adapter 34, as a second or slave adapter.

As will become apparent, in this master/slave mode of operation, integrated graphics adapter 34 is substantially disabled. However, components of on-board graphics adapter 34 (and in particular display interface 44) may still be used to drive interconnected monitors and other display devices. As such, card 50 need not include multiple display ports and display drivers. Instead, display interface 44 and its port(s) 48 may be used to drive at least one monitor or display 32, in addition to the display 68 or displays driven by card 50. If adapter 52 includes multiple ports (such as ports 64, 66), processor 52 may additionally render images for presentation through these multiple ports. Of course, driver software 108 may also allow operation of adapter 34 in its conventional mode of operation, described above. Selection of the mode of operation of adapter 34 (and hence adapter 52) may be made by or through application software 106.

Specifically, in the master/slave mode of operation, exemplary of embodiments of the present invention, driver software 108 within memory 16 allocates an active frame buffer 70 and a secondary adapter buffer 72 within memory 56 of adapter 52, as schematically depicted in FIG. 4. The active frame buffer 70 functions as a conventional frame buffer for adapter 52, and thus stores frames for display on display 68 of adapter 52. As such, graphics processor 54 renders 2-D or 3-D graphics in the active frame buffer 70 within memory 56 in a conventional manner. Display interface 62 of card 50 converts contents of the active frame buffer 70 for display on an interconnected monitor or display device. Optionally, active frame buffer 70 may be replaced by front and rear buffers, as described above.

Graphics processor 54 further renders images for display on a display device 32 within secondary adapter frame buffer 72. At the conclusion of rendering a frame within secondary adapter frame buffer 72, the contents of secondary adapter frame buffer 72 are transferred to frame buffer 46 for presentation by display interface 44 of graphics adapter 34, as detailed below.

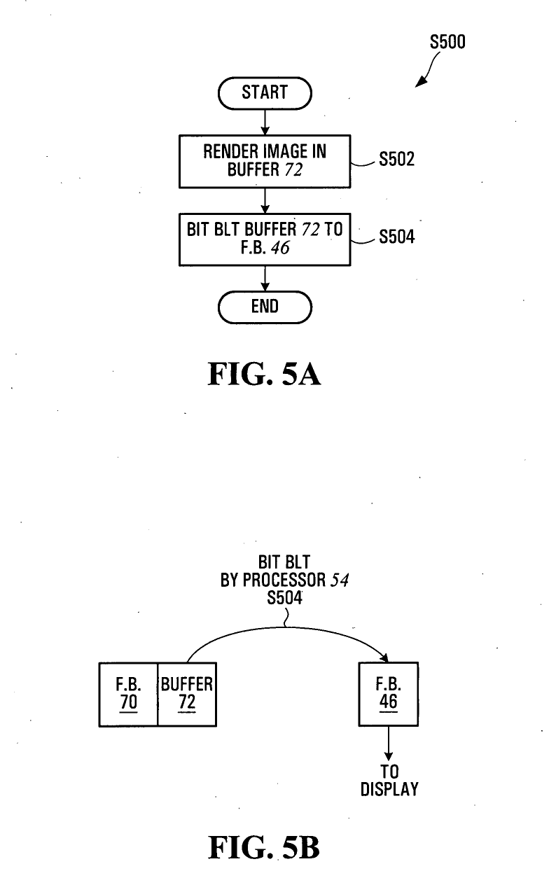

In a first embodiment, graphics adapter driver software 108 within memory 16 performs steps S500 depicted in FIG. 5A. Specifically, driver software 108 generates commands directing graphics processor 54 to render the secondary adapter buffer 72 of memory 56, in steps S502. These commands are placed in the command queue 57 of adapter 52 and executed by graphics processor 54, in much the same way as commands would be queued in queue 47, as described above. Once the frame is rendered, driver software 108 further generates a command (or commands) causing processor 54 to bit block transfer (BITBLT) the contents of secondary adapter frame buffer 72 within memory 56 in step S504, to that area of memory 16 allocated as frame buffer 46 for graphics adapter 34.

Display interface 44 of graphics adapter 34, in turn, has been pre-programmed to display the contents of its frame buffer 46 to an interconnected monitor or display at port 48. Conveniently then, images displayed on displays 32 and 68 interconnected with ports 48 and port 64 are rendered or drawn by graphics processor 54. The effects of step S504 on buffer 72 and frame buffer 46 is illustrated in FIG. 5B.

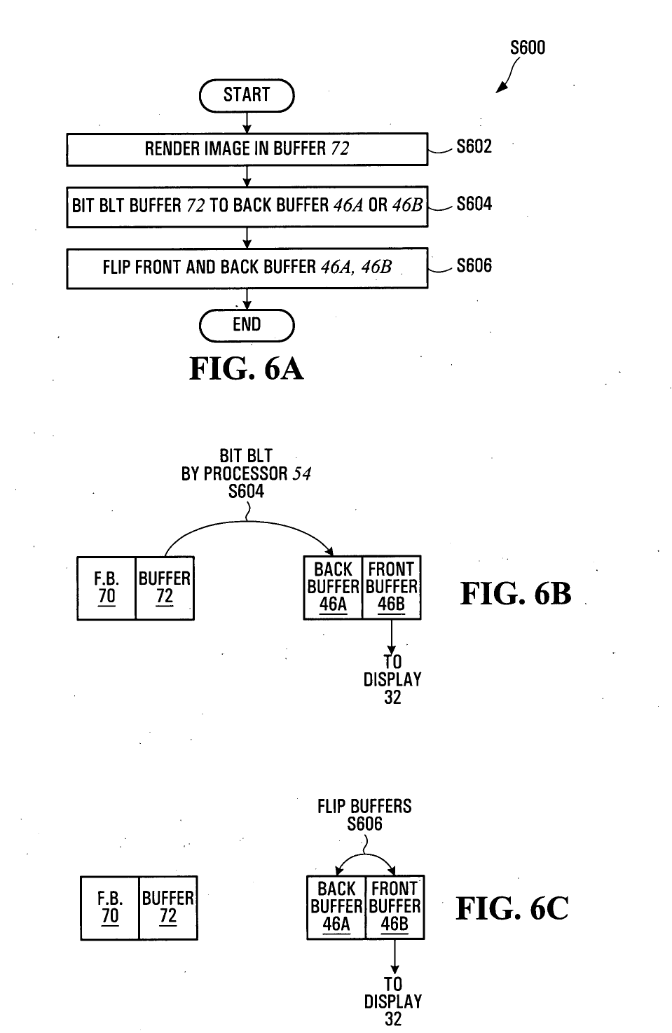

In a second embodiment, steps S600 depicted in FIG. 6A are performed. Initially, front and back frame buffers are allocated within memory 16 of adapter 52. For convenience these are designated as buffers 46a and 46b, and depicted in FIG. 6B. Processor 54 again renders any frame to presented by display interface 44 within secondary adapter frame buffer 72 of memory 56 as described above with reference to step S502, in step S602.

At the conclusion of rendering a frame for display on device 32, driver software 108 programs graphics processor 54 to bit block transfer (BITBLT) the contents of secondary adapter frame buffer 72 within memory 56, to the then current back buffer within memory 16 for graphics adapter 34 in step S604. Upon completion of the BITBLT, driver programs processor 54 to program registers of display interface 44 to flip the back buffer and front buffer of adapter 34 (i.e. use the back buffer as the front buffer), in step S606. This may be done by directly reprogramming the register of display interface 44 identifying the start address used by display interface 44 for presentation of data. Display interface 44 of graphics adapter 34, in turn, presents the contents of it's the buffer to an interconnected monitor (i.e. display 68) at port 48. The previous front buffer, in turn, is now used as back buffer for adapter 34, and the next frame rendered by processor 54 for display on display 32 will initially be transferred to this back buffer in step S604. Driver software 108, of course, maintains the start location and status of each buffers 46a and 46b as front and back buffers. The effect of steps S604 and S606 on buffers 46a and 46b is schematically illustrated in FIG. 6B.

Without synchronization, use of a single buffer 46 or direct programming of display interface 44 of adapter 34 may cause visible tearing. That is, any time outside of the vertical blanking interval that registers of display interface 44 are reprogrammed, tearing may be visible, as display parameters are changed in the middle of the frame output by interface 44.

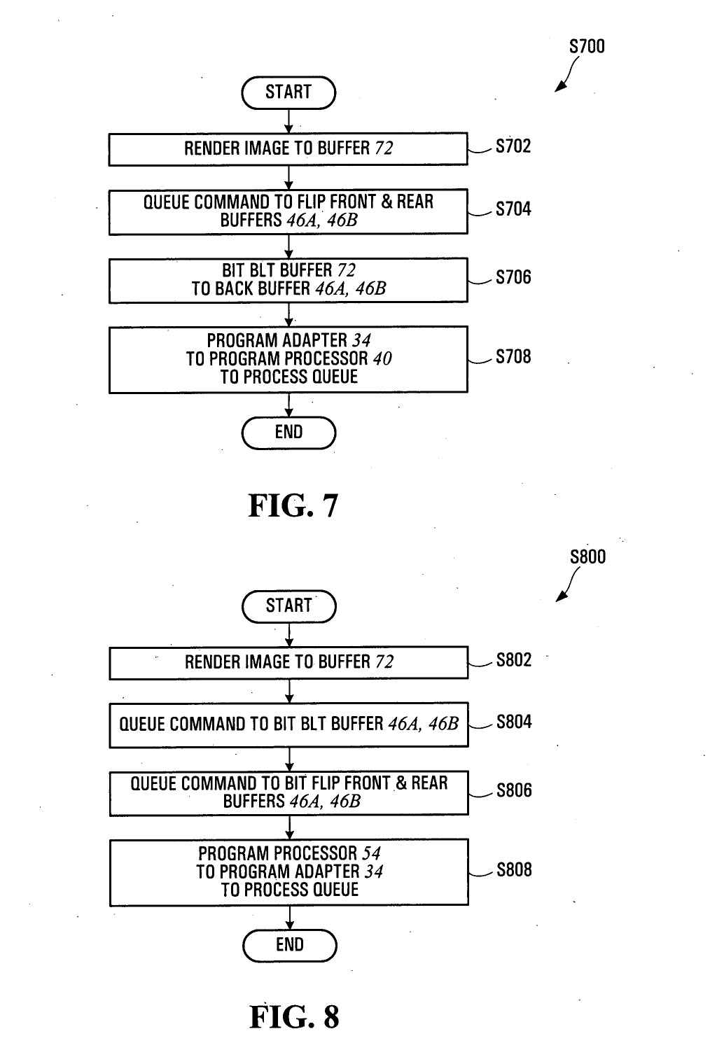

Thus, in yet a third embodiment, steps S700 depicted in FIG. 7 may be performed. Again, front and rear buffers 46a, 46b are initially allocated within memory 16 used by adapter 34. Processor 54 again renders images for display at device 32 within buffer 72 of local memory 56, as described above with reference to steps S502 and S602.

At the completion of rendering a frame for display on display 32, driver software 108 within memory 16 programs graphics processor 54 to bit block transfer (BITBLT) the contents of secondary adapter frame buffer 72 within memory 56, to the then current back buffer within memory 16 of graphics adapter 34 in step S704. Driver software 108 further places a command in the command queue 47 of adapter 34 to flip front and back buffers, in step S706. However, registers of command processor 42 are not updated by driver software 108 to reflect the pending command in command queue 47. Instead, driver software 108 provides a command to graphics processor 54 in step S708 to update command queue registers of command processor 42 upon completion of the bit block transfer initiated in step S706. This, in turn causes command processor 42 to provide instructions to processor 40 to flip its back to front buffer. Graphics processor 40, in turn executes the queued command to flip back and front buffers of adapter 34 (i.e. by reprogramming registers of display interface 44 to present the contents of its previous back buffer to an interconnected monitor or display at port 48).

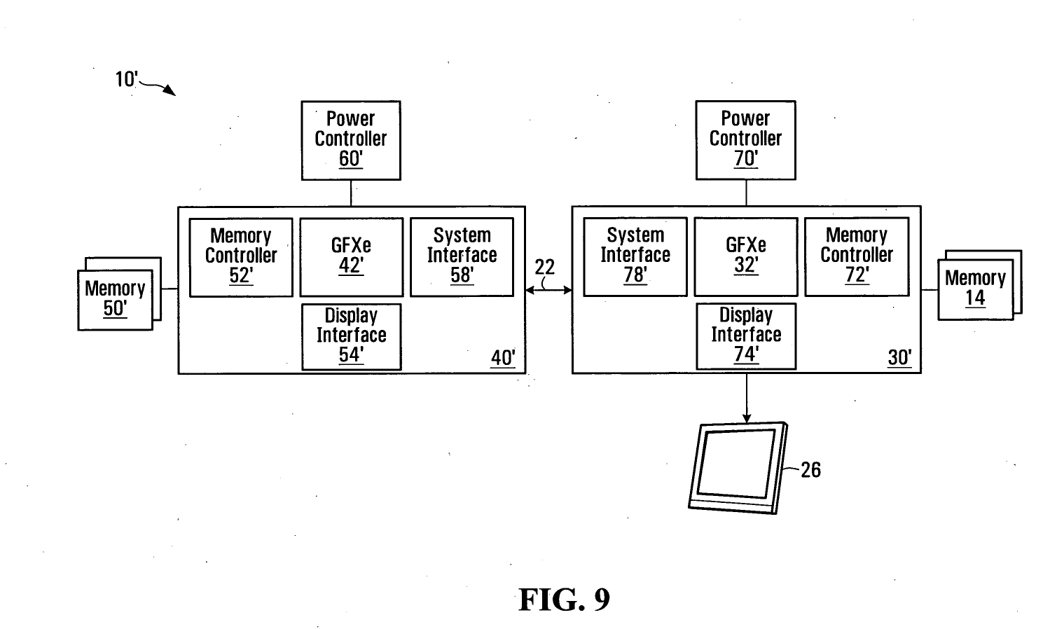

In yet a fourth embodiment, steps S800 depicted in FIG. 8 are performed. Again, front and back buffers are initially allocated within memory 16 of adapter 34. Processor 54 again renders images for display 32 within buffer 72 of local memory 56, as described above.

Driver software 108 further places a command in queue 47 of adapter 34 to cause graphics processor 40 to bit block transfer (BITBLT) the contents of the secondary frame buffer 72 within memory 56, to that area of system memory 16 allocated as the current back frame buffer for graphics adapter 34. Driver software 108 also places a command in queue 47 to cause graphics processor 40 to flip front and back buffers of adapter 34 by programming display interface 44 to use the rear buffer as front buffer. However, registers of command processor 42 defining the queue pointer are not updated until a frame has been rendered in buffer 72.

So, at the conclusion of rendering a frame for display 32, graphics processor 54 provides a command to update command registers defining the queue pointer for command processor 42 to reflect the two pending commands within the command queue of adapter 34. Graphics processor 40, in turn executes the queued commands to bit block transfer the contents of buffer 72 to its back buffer and flip its back and front buffers (i.e. by reprogramming registers of display interface 44 to present the contents of its previous back buffer to an interconnected monitor or display at port 48).

As will now be appreciated, the above described embodiments allow a master graphics processor to assume responsibility for drawing two or three dimensional graphics images on multiple independent frame buffers. A slave graphics adapter may be used to display images created in one frame buffer. Device electronics and ports required to drive additional displays may be provided by slave graphics adapter 34. In this way, electronics included in the slave graphics controller may be effectively utilized to allow driving of multiple displays.

Conveniently, buffers 70 and 72 may be used to define a single surface on which application software 106 may render single graphic images to be displayed across two or more displays 48 and 64, interconnected with graphics adapters 52 and 34. Driver software 108 may accordingly report an available screen size to application software 106, equal to the size of buffer 70 and buffer 72. Thus, if buffer 70 has a resolution of m.sub.1×n and buffer 72 has a resolution of m.sub.2×n, driver software 108 may report an available screen size of (m.sub.1+m.sub.2)×n to an application of application software 106. Rendering by driver software 108 is simplified if buffers 70 and 72 occupy adjacent (m.sub.1+m.sub.2)×n pixel locations within memory 56. Application software 106 may, in turn use driver software 108 to cause graphics processor 40 to render larger images having a resolution of (m.sub.1+m.sub.2)×n pixels making up the surface defined by buffers 70 and 72. Buffers 70 and 72 thus store image pairs, with each image of the pair forming a portion of the larger image rendered by the application. At the conclusion of rendering each larger image, driver software 108 may transfer the image in buffer 72 to frame buffer 46, for display on display 32, in accordance with steps S500, S600, S700 or S800 described above. The image in buffer 70 may be displayed on display 68 in normal fashion. An end user viewing displays 32 and 68 side by side recognizes the larger image rendered by application 106. As will be appreciated, application 106 in the form of a game may take advantage of multiple displays, without requiring modification.

If front and back buffers are used for display 68, two different buffers may be allocated and used in place of buffer 72, to ensure that the buffer holding the surface portion to be displayed on display 32 is adjacent in memory 56 to the buffer in which the surface portion to be displayed on display 68 is being rendered Steps S602, S604, S702, S704, or steps S802, S704 could accordingly be modified to bit block transfer the buffer holding the just completed image to the back buffer 46a or 46b. Conveniently, existing application software 106 need not be modified. Instead, the application software may simply rely on the reported larger screen size. Driver software 108 causes the rendering of surfaces across multiple displays.

As will now also be appreciated, although the depicted embodiment utilizes an integrated graphics controller as a slave graphics adapter, the slave graphics adapter could easily be another graphics adapter in communication with graphics adapter 52 by way of a bus having sufficient bandwidth to allow transfer of graphics frames into the slave frame buffer(s). As such, the slave graphics processor could be formed as another PCIe compliant expansion card. So, for example, as graphics cards are upgraded, older expansion cards may still be used for their ability to drive interconnected displays. Similarly, the interconnect bus need not be a PCIe interconnect bus, but could be any other suitable bus having a bandwidth allowing transfer of data between frame buffers at a rate equal to the refresh rate used by display interface 44. Likewise, although frame buffers 46 (and front and back buffers 46a and 46b) have been described as being formed in system memory 16, they could easily be formed as part of memory local to adapter 34.

In yet another alternate embodiment of the present invention, rendering across bus 22, may allow a graphics adapter (or subsystem) interconnected by high speed bus 22 to take the place of an integrated adapter/subsystem.

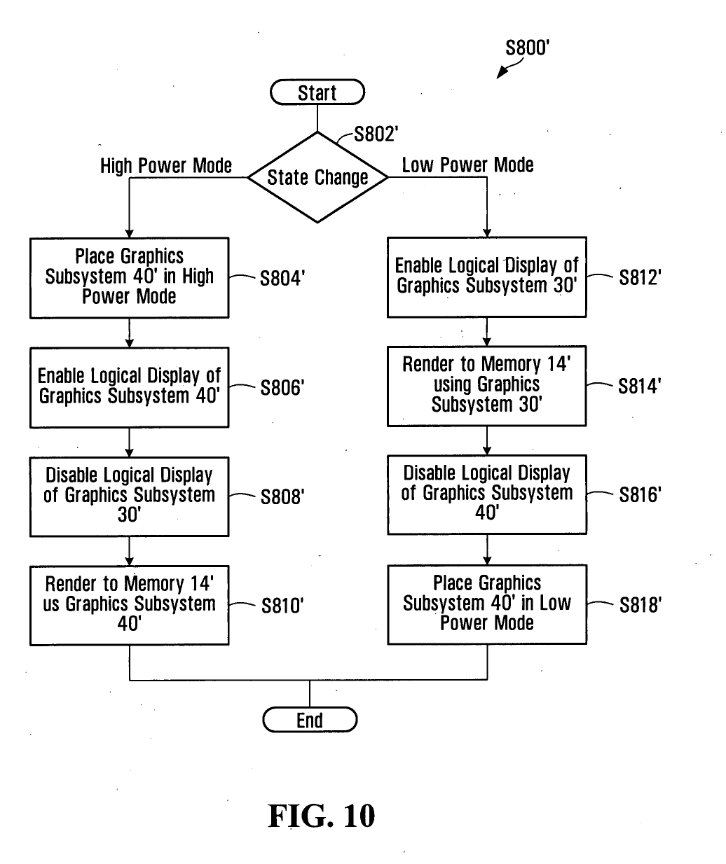

To this end, FIG. 9 is a simplified block diagrams exemplary of a portion of a computing device 10′ exemplary of another embodiment of the present invention. Computing device 10′ is detailed in U.S. patent application Ser. No. 11/421,005.

Briefly, however, device 10′ includes two graphics subsystem 30′ and 40′. Graphics subsystem 30′ includes a graphics engine/processor 32′, a memory controller 72′, a display interface 74′ and a bus interface 78′. A second graphics subsystem 40′ is, in communication with graphics subsystem 30′, by way of high speed bus 22′, such as the PCIe bus. Graphics subsystem 40′ includes its own graphics engine/processor 42′; memory controller 52′; display interface 54′. Graphics subsystem 40′ is further in communication with graphics memory 50′. As will becomes apparent, subsystem 40′ is adapted to render graphics to memory 14′, across bus 22′.

Device 10′ may conveniently be formed as a portable computing device in the form of a laptop or smaller computing device. As such, a single housing may contain a DC power source, display 26′ and the above mentioned motherboard and components. The second graphics subsystem 40′ may be added to a single housing that houses the remainder of the computing device, or may form part of a docking station that only forms part of device 10′, when device 10′ is physically interconnected thereto.

Device 10′ may be operated in at least two power consumption modes: a higher power consumption mode and a lower power consumption mode. In the depicted embodiments, device 10′ the higher power mode may be assumed when device 10′ is powered by a power source connected to an AC(mains) supply; the lower power consumption mode may be assumed when device 10′ is powered by a DC power source using one or more batteries, fuel cells, or the like. Alternatively, power consumption modes may be user selected, software controlled, based on for example, user preferences, types of software applications being executed, battery levels, and the like, or otherwise chosen.

The organization of software controlling operation of device 10′ is disclosed in U.S. patent application Ser. No. 11/421,005, and shares similarity to software 100, described above.

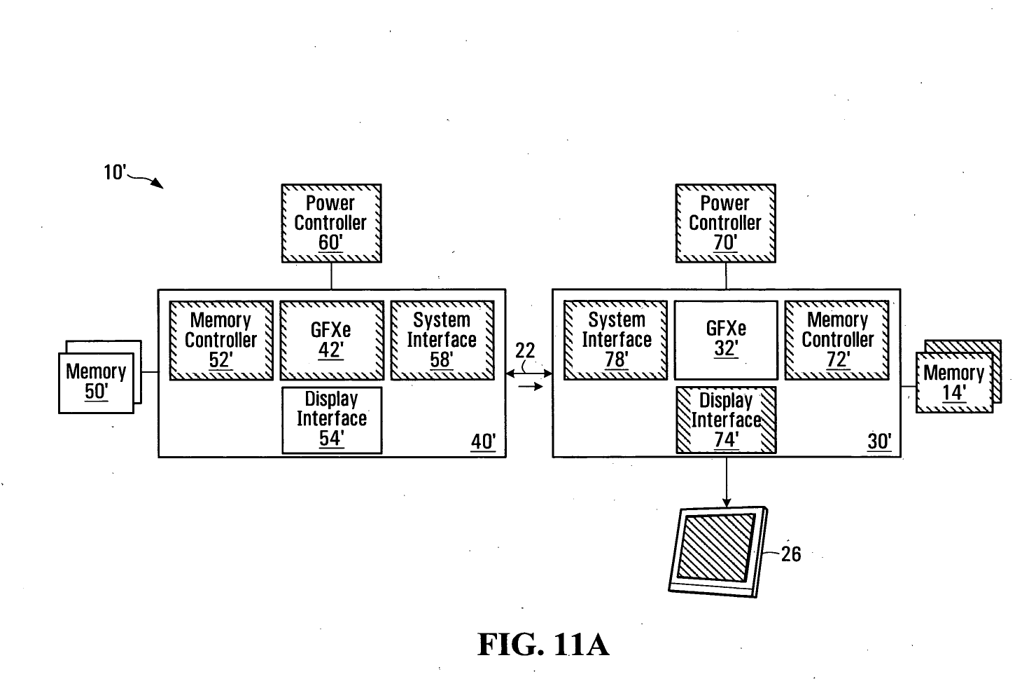

Portions of the software controlling operation of device 10′ as device 10′ transitions between high and low power consumption states. Specifically FIG. 10 depicts software blocks S800′, exemplary of embodiments of the present invention that may be performed by a central processor (like processor 12—FIG. 1) under control of software within system memory of device 10′. Blocks S800′ may be performed each time device 10′ undergoes a state change, for which subsystems 30′ and 40′ should be configured accordingly. As illustrated, in block S802′ the software determines whether device 10′ should assume its higher power consumption mode, or its lower power consumption mode.

When device 10′ is to resume (or transition) to its high power consumption mode, blocks S804′-S810′ are executed. In block S804 graphics subsystem 40′ is placed in its full operational (high power consumption) mode, if it is not already in this mode. This may be performed by providing an appropriate signal to power controller 60′, through the driver controlling graphics subsystem 40′. Next, graphics subsystem 40′ is enabled in blocks S806 and S808. Again, this may be performed by logically disabling any display interconnected associated with graphics subsystem 30′ in block S804, and logically enabling the display connected with graphics subsystem 40′, in block S808. Blocks S806 and S808 may again be performed, by appropriate operating system API calls, such as the EnumDisplayDevices( ) and ChangeDisplaySettingsEX( ) calls described in the Ser. No. 11/421,005 patent application, or through direct communication with hardware.

Notably, no physical display is connected to graphics subsystem 40′. Driver software controlling operation of graphics subsystem 40′ is configured to render images in buffer 14′ of graphics subsystem 30′ instead of within associated memory 50′ in step S810′. Conveniently, in the presence of high speed bus 22′ (embodied, for example, as the PCIe bus), such rendering is possible across bus 22′, owing in part to transfer speeds enabled by the bus.

The rendering may be direct into the frame buffer across the bus, primitive by primitive, thus transferring the rendered image across bus 22′. This may be facilitated by allocating buffer 14′ in memory accessible by subsystem 40′ and providing the driver software for subsystem 40′ with the address of buffer 14′. Alternatively, as will become apparent, the frames may be rendered in one buffer, and transferred by direct memory access or the like across bus 22′.

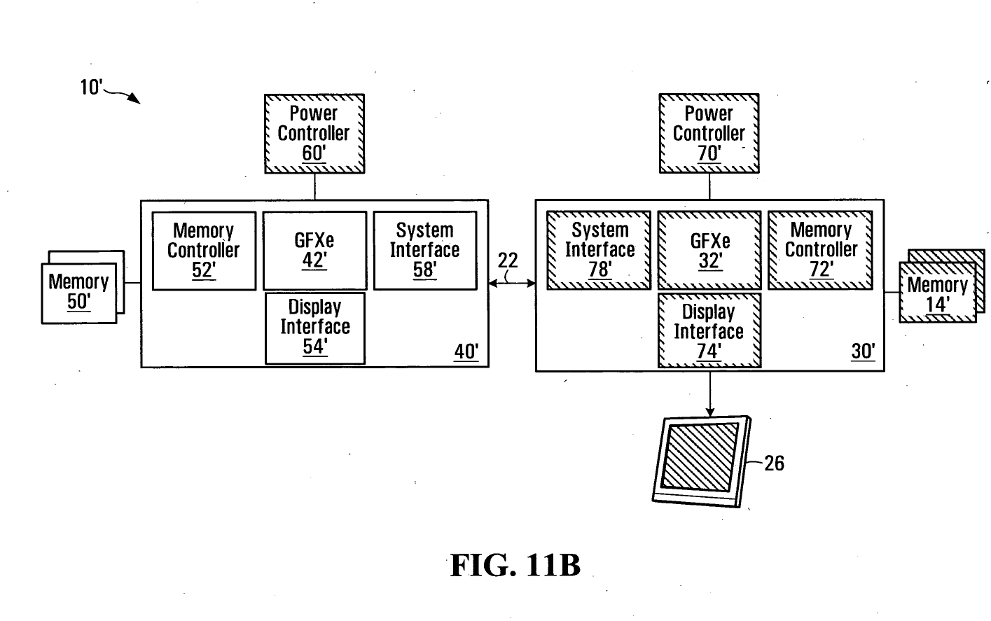

As well, the driver for graphics subsystem 30′ is further configured to cause display interface 74′ of graphics subsystem 30′ to sample the frame buffer in memory 14′, so as to present the image rendered by graphics subsystem 40′ in the frame buffer in memory 14′ at interconnected display 26′. At the same time, the driver for graphics subsystem 30′ may direct graphics engine 32′ of graphics subsystem 30′ to remain substantially dormant or idle. This mode of operation is schematically depicted in FIG. 11A with only the active blocks of graphics subsystem 40′ and graphics subsystem 30′, crosshatched.

As will be apparent, in the embodiment of FIG. 11A memory 50′ and display interface 54′ are not used. As such, these functional blocks could be eliminated from subsystem 40′ allowing cost reduction. The resulting subsystem 40′ need not include a display interface and would lack memory defining a frame buffer local to subsystem 40′. Producing such a graphics subsystem may be beneficial, as subsystem 40′ could be produced to complement the functionality provided by subsystem 30′. For example, subsystem could provide a graphics engine 42′ that provides 3D graphics or video decoding capabilities. Graphics engine 32′ may not include these capabilities. At the same time, 2D graphics abilities offered by graphics engine 32′ need not be included in subsystem 40′. Consumers, in turn could add graphics subsystem 30′ only when additional functionality is needed.

When device 10′ is to transition to, or resume its low power consumption mode, blocks S812′-S818′ are executed. Broadly speaking, graphics subsystem 40′ is partially or completely disabled and placed in its low power consumption mode, and rendering is again performed by graphics subsystem 30′. To do so, any display interconnected associated with graphics subsystem 30′ may be enabled in block S812′, and any display physically connected with graphics subsystem 40′ may be logically disabled in block S814′. Next, driver software controlling operation of graphics subsystem 30′ is again configured to cause graphics subsystem 30′ to render images in memory 14′. Display interface 74′ continues to sample memory 14′ to present images on display 26′ interconnected with port 78′. As well, processor 12′ first provides a suitable signal to power controller 60′ in block S818′, placing graphics subsystem 40′ in its low power state. In its simplest form, a power controller (not shown) disconnects power to graphics subsystem 40′ or places graphics subsystem 40′ into a lower power sleep mode. Again, in this lower power consumption mode, voltages are throttled, and/or all or parts of graphics subsystem 40′ are powered down and/or selected clocks used by graphics subsystem 40′ are slowed. Specifically, the graphics engine 42′ of graphics subsystem 40′ remains idle or substantially idle (e.g. it may be slowed, disable or powered down). This mode of operation is schematically depicted in FIG. 9B with only the active functional blocks of adapter 40′ and graphics subsystem 30′, crosshatched. The inactive/idle functional blocks may be entirely disabled, or operated at reduced voltages or clock speeds.

Optionally, portions of graphics subsystem 30′ could be disabled when graphics engine 32′ is not in use. This could be facilitated by placing graphics engine 32′ and other components on one or more voltage islands that may be disabled by way of a GPIO or similar circuit, any time graphics subsystem 40′ is responsible for rendering images.

Other variations should also be apparent. For example, in high power modes depicted in FIG. 11A, both graphics subsystem 30′ and graphics subsystem 40′ could render to memory 14′ or memory 50′. In this way, the two graphics subsystems 30′ and 40′ may operate in concert, each rendering an alternate frame in memory 14′ or rendering an alternate portion (e.g. scan-line) of each frame in memory 14′.

In yet other embodiments, additional displays may be connected to graphics subsystems 30′ and 40′ allowing concurrent use of multiple displays in the high power consumption modes, as detailed above. In this way, display interface 54′ could be used to drive a second display. Upon transition to a lower power consumption mode, device 10′ could be configured to operate as depicted in FIG. 11B.

Similarly, device 10′ (or 10) could include multiple additional graphics subsystems connected to bus 22′ (or 22), all of which could be active in the high power consumption mode, and render graphics through display interface 74′ of graphics subsystem 30′. Upon transition to the lower power consumption mode, these could be disabled and rendering could be left to graphics engine 32′ of graphics subsystem 30′.

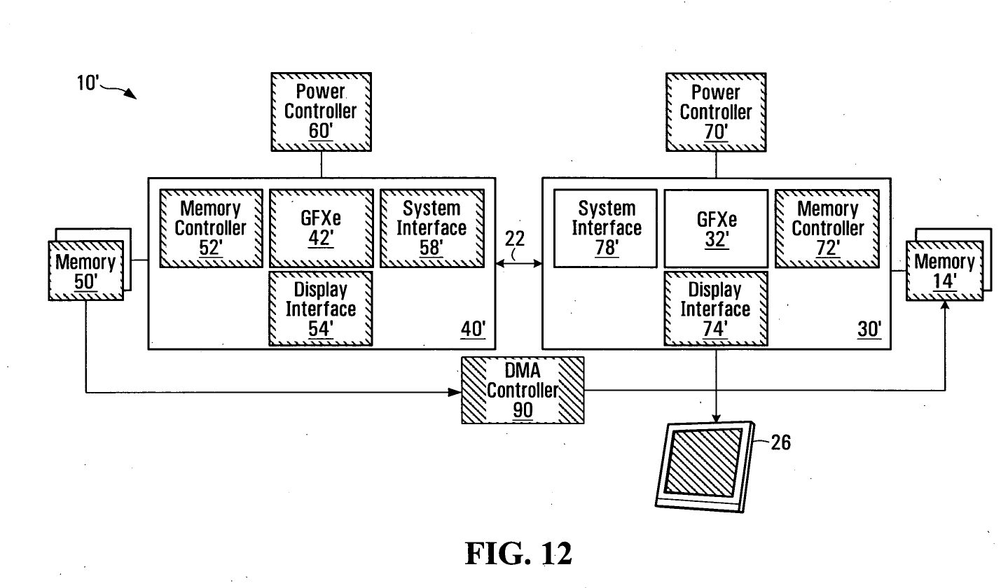

In yet another embodiment depicted in FIG. 12, computing device 10′ may include a direct memory access (DMA) controller 90. DMA controller 90 may transfer data from memory 50′ to memory 14′. In this way, in a higher power consumption mode of device 10′, graphics subsystem 40′ could render images to memory 50′. These rendered images could then be transferred by DMA controller 90 to a frame buffer in memory 14′. DMA controller 90′ could form part of graphics subsystem 30′ or 40′ (for example as DMA engines of graphics engines 32′ or 42′), or be otherwise located in computing device 10′. Data may be transferred across bus 20′ or otherwise directly from memory 50′ to memory 14′. Display interface 74′ would continue operating as disclosed above, sampling the frame buffer in memory 14′ to present the rendered image on display 26′. Again, active blocks of device 10′ of FIG. 10, in its higher power consumption mode are illustrated in crosshatch in FIG. 12.

Of course, the above described embodiments are intended to be illustrative only and in no way limiting. The described embodiments of carrying out the invention are susceptible to many modifications of form, arrangement of parts, details and order of operation. Rather, the invention is intended to encompass all such modification within its scope, as defined by the claims.

What is claimed is:

1. A method of operating a computing device, said computing device comprising a processor, a memory in communication with said processor, a peripheral interconnect bus interconnecting said processor to a graphics processor, and a display interface, said method comprising:
establishing a frame buffer in said memory;
instructing said graphics processor to render video frames;
transferring said video frames into said frame buffer by way of said peripheral interconnect bus; and
presenting said frames from said frame buffer on a display by way of said display interface.

2. The method of claim 1, wherein said instructing said graphics processor comprises rendering frames into a second frame buffer, and transferring said frames from said second frame buffer to said frame buffer.

3. The method of claim 2, wherein said graphics processor is part of a first graphics adapter, and said second frame buffer is in a local memory of a second graphics adapter.

4. The method of claim 1, wherein said transferring comprises instructing said graphics processor to comprises render directly into said frame buffer by way of said peripheral interconnect bus.

5. The method of claim 1, wherein said instructing comprises instructing said graphics processor to transfer said video frames over said peripheral interconnect bus into said frame buffer.

6. The method of claim 1, wherein said instructing comprises instructing a direct memory access controller to transfer said video frames into said frame buffer.

7. The method of claim 1, further comprising programming said display interface to present said frames in said frame buffer on said display.

8. The method of claim 3, wherein said presenting comprises programming said display interface to display images from said second frame buffer.

9. The method of claim 1, wherein said instructing said graphics processor comprises instructing said graphics processor to render said frames in a buffer in communication with said graphics processor, and wherein said transferring comprises direct memory access transferring said frames, from said buffer to said frame buffer.

10. A computing device, comprising:
a central processor,
a memory in communication with said central processor,
a peripheral interconnect bus interconnecting said central processor to a graphics processor,
a display interface;
computer executable instructions stored in said memory, adapting said computing device to:
cause said graphics processor to render video frames;
transfer said video frames into a frame buffer by way of said peripheral interconnect bus;
present said rendered frames from said frame buffer on a display by way of said display interface.

11. The computing device of claim 10, wherein said display interface forms part of a peripheral expansion interface.

12. The computing device of claim 11, wherein said graphics processor forms part of a peripheral expansion card, in a peripheral expansion slot in communication with said peripheral interconnect bus.

13. The computing device of claim 10, wherein said graphics processor forms part of a graphics subsystem that lacks frame buffer memory and a display interface.

14. The computing device of claim 10, wherein said video frames are transferred into said frame buffer by way of said peripheral interconnect bus, by directly rendering said video frames into said frame buffer.

15. A computing device, comprising:
a central processor;
memory in communication with said processor;
a first frame buffer;
a peripheral interconnect bus interconnecting said processor to a graphics subsystem, said graphics subsystem lacking memory defining a frame buffer local to said graphics subsystem; and
a display interface in communication with said memory,
said memory storing computer executable instructions adapting said graphics processor to render video frames and transfer said video frames into said first frame buffer by way of said peripheral interconnect bus.

16. The computing device of claim 15, wherein said graphics subsystem is formed on a peripheral expansion card interconnected with said peripheral interconnect bus.

17. The computing device of claim 15, further said display interface forms part of a peripheral expansion interface.

18. The computing device of claim 15, wherein said display interface forms part of said graphics subsystem on a peripheral expansion interface interconnecting said central processor to said peripheral interconnect bus.

19. A graphics subsystem, comprising:
a graphics processor, and a peripheral interconnect bus interface, for interconnecting said graphics subsystem to a host processor, said graphics subsystem lacking memory defining a frame buffer local to said graphics subsystem; and
said graphics subsystem operable to render video frames and transfer said video frames into a frame buffer by way of said peripheral interconnect bus.

20. Computer readable medium, storing computing executable instructions that adapt a computing device to perform the method of claim 1.
